(19) United States
(12) Patent Application Publication
(10) Pub. No.: US 2012/0072836 A1
(43) Pub. Date: Mar. 22, 2012

(54) Displaying system of translation words and displaying method thereof

(75) Inventors: Chaucer Chiu, Taipei (TW); Ting Dong, Shanghai (CN)

(73) Assignee: INVENTEC CORPORATION, Taipei (TW)

(21) Appl. No.: 12/928,630

(22) Filed: Dec. 14, 2010

(30) Foreign Application Priority Data
Sep. 21, 2010 (TW) 099131968

(51) Int. Cl. G06F 17/21

(52) U.S. Cl. 715/259

(57) ABSTRACT

A displaying system of translation words and a displaying method thereof are provided. By initializing a translation area, a plurality of sub-areas are simultaneously displayed to receive an inquire word in each of them. The inquire word in each of the sub-areas is translated respectively to display the translation words and word explanations thereof. The mechanism increases convenience of comparing the translation words.

### BACKGROUND OF THE INVENTION

1. Field of Invention

The invention relates to a displaying system and the displaying method thereof. In particular, the invention relates to a displaying system of translation words that looks up translation words in multiple sub-areas for their word explanations, and the displaying method thereof.

2. Related Art

In recent years, due to the popularity of Internet and the trend of internationalization, users have more chances to encounter multilingual documents. Therefore, there are a lot of translating procedures that help users understanding meanings of words on the market.

Generally speaking, a translating procedure is accompanied with a translation database. The translation database stores translation words and their corresponding explanations. After a user enter an inquiry word, the procedure looks for a corresponding translation word in the translation database, so that the user can learn the meanings of the inquiry word. However, since the usual translating procedure only allows the input of one inquiry word at a time instead of multiple inquiry words simultaneously, the user often has the trouble that he forgets the explanations of the previous word during the current search.

In view of this, some vendor proposes the method of recording previous search of word translations and their corresponding explanations into a history. As a result, the user can browse the history to review what he has searched before. Although this method can prevent the user from losing previously searched words, it becomes extremely inconvenient once the number of recorded translation words and their explanations increases indefinitely. Therefore, this method of generating a history record is of limited help to users. It is a better solution for the translating procedure to allow the input of multiple inquiry words at a time and simultaneously display the searching results for comparison.

In summary, the prior art always has the problem of impossible to input multiple inquiry words at the same time for searching and comparison. The invention thus aims at solving this problem.

### SUMMARY OF THE INVENTION

In view of the foregoing, the invention discloses a displaying system of translation words and the displaying method thereof.

The disclosed displaying system of translation words includes: a translation database, an initializing module, a receiving module, and a translating module. The translation database stores a plurality of translation words, each of which includes word explanations. The initializing module initializes a translation area consisting of a plurality of sub-areas. The receiving module receives the inquiry word in each of the sub-areas. The translating module compares the inquiry words with the translation words in the translation database, and displays the matched translation words and the at least one associated word explanation in the sub-areas of the corresponding inquiry words.

In addition, the disclosed system can further includes an extracting module for the user to extract a plurality of words with the cursor and to insert the extracted words into the sub-areas as the corresponding inquiry words. The translation area in the above-mentioned system allows addition and/or deletion of the sub-areas. The sub-areas can be displayed horizontally or vertically at the same time. It should be emphasized that the sub-area is a floating window that allows the user to move it by pressing a function key or by dragging the cursor.

The disclosed displaying method of translation words includes the steps of: storing a plurality of translation words in a translation database, each of the translation words having at least one associated word explanation; initializing a translation area that has a plurality of sub-areas; receiving an inquiry word in each of the sub-areas; comparing each of the inquiry words with the translation words in the translation database, and displaying matched translation words and the at least one associated word explanation in the sub-areas of the corresponding inquiry words.

It should be emphasized that the above-mentioned method can further include the step of extracting a plurality of words using the cursor and embedding the words into the sub-areas as the corresponding inquiry words. Besides, the translation area in the disclosed method allows addition and/or deletion of the sub-areas. The sub-areas can be displayed horizontally or vertically at the same time. It should be emphasized that the sub-area is a floating window that allows the user to move it by pressing a function key or by dragging the cursor.

The disclosed system and method differ from the prior art in that the invention initializes the translation area so that it can simultaneously display several sub-areas. The user thus can enter inquiry words in the sub-areas for searching and comparison.

Using the disclosed system and method, the user can conveniently compare the translation words.

### BRIEF DESCRIPTION OF THE DRAWINGS

The invention will become more fully understood from the detailed description given herein below illustration only, and thus is not limitative of the present invention, and wherein:

FIG. 1 is a block diagram of the disclosed displaying system of translation words;

FIG. 2 is a flowchart of the disclosed displaying method of translation words;

FIG. 3 is a schematic view of the translation area according to the invention;

FIG. 4 is a schematic view of using the invention to simultaneously translate two inquiry words;

FIG. 5 is a schematic view of switching the arrangement of sub-areas according to the invention;

FIG. 6 is a schematic view of deleting a sub-area according to the invention;

FIG. 7 is a schematic view of adding a sub-area according to the invention; and

FIG. 8 is a schematic view of using the cursor to simultaneously extracting multiple words according to the invention.

### DETAILED DESCRIPTION OF THE INVENTION

The present invention will be apparent from the following detailed description, which proceeds with reference to the accompanying drawings, wherein the same references relate to the same elements.

Those Chinese characters shown in the drawings are just mentioned for describing the embodiments and are substantially irrelevant to any technical matters.

Before explaining the disclosed displaying system and method of translation words, we first define the terms used in this specification. The translation area referred herein is a window interface for translation searches. This window interface contains several sub-areas displayed simultaneously. The sub-area here is an operating block that allows the input of an inquiry word and searches the corresponding word explanations. The translation area and the sub-areas will be further described with reference to accompanying figures. It should be noted that the invention does not impose any constraint of the number of sub-areas and how they are presented.

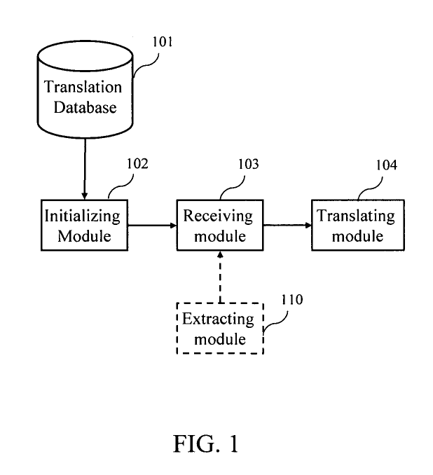

Please refer to FIG. 1 for the system block diagram of the disclosed displaying system of translation words. It includes: a translation database 101, an initializing module 102, a receiving module 103, and a translating module 104. The translation database 101 stores translation words, each of which has at least one associated word explanation. For example, the translation word is “shy,” the word explanation is “shy (in Chinese).” In practice, the translation database 101 can be implemented with a relational database or file document.

The initializing module 102 initializes a translation area, which contains several sub-areas. The initialization is to simultaneously display several sub-areas in the translation area. In other words, the system repeatedly executes the correlation function of translation inquiry view to generate and display multiple sub-areas in the translation are. Each of the sub-areas is designated with an identification (ID) in order to distinguish them. In practice, these sub-areas can be displayed together horizontally or vertically. It should be noted that the translation area allows addition and/or deletion of the sub-areas. Moreover, the sub-area is a floating window. The user can press a function key or use the mouse to drag the floating window to a new place.

The receiving module 103 receives the inquiry word in each of the sub-areas. For example, suppose the translation area displays simultaneously two sub-areas. The first sub-area is entered with the word “book,” and the second sub-area is entered with the word “pen.” Once the inputs are confirmed (e.g., by pressing the “Enter” key on a physical keyboard), the receiving module 103 receives the word “book” as the inquiry word of the first sub-area and the word “pen” as the inquiry of the second sub-area.

The translating module 104 compares each of the inquiry words with all the translation words in the translation database 101, and shows the matched translation words and the associated explanations in the sub-areas of the corresponding inquiry words. In the above example, the translating module 104 compares the inquiry words “book” and “pen” with all the translation words in the translation database 101. Suppose the translation database 101 contains the translation words “book” and “pen.” After the comparison, the system obtains results that match with the translation words “book” and “pen.” The translation word “book” and the associated word explanation “book (in Chinese)” are shown in the sub-area corresponding to the inquiry word “book” (i.e., the first sub-area). The translation word “pen” and the associated word explanation “pen (in Chinese)” are shown in the sub-area corresponding to the inquiry word “pen” (i.e., the second sub-area).

Besides, the disclosed displaying system of translation words can further include an extracting module 110 for simultaneously extracting several words using the cursor. It further embeds the extracted words into the sub-areas as the corresponding inquiry words. In practice, one can use the cursor to mark text and decompose the text into several words. These words are then embedded into the sub-areas as the corresponding inquiry words. This part will be explained in further detail later.

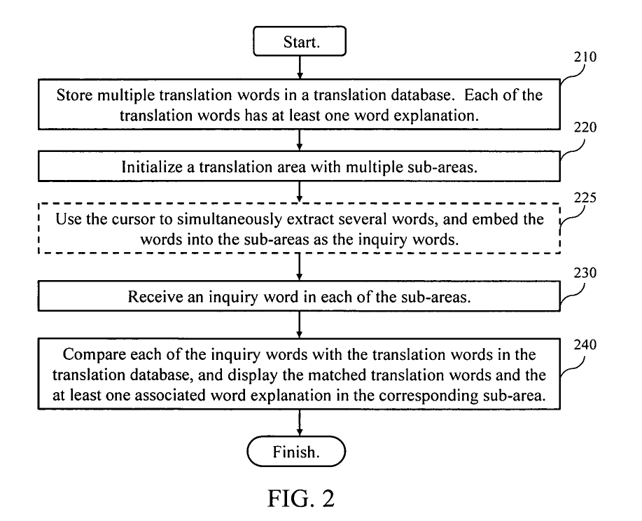

Please refer to FIG. 2 for the flowchart of the disclosed displaying method of translation words. The method includes the following steps. In step 210, a translation database stores several translation words, each of which has at least one associated word explanation. In step 220, a translation area is initialized to include several sub-areas. In step 230, each of the sub-areas receives a corresponding inquiry word. In step 240, each of the inquiry words is compared with all the translation words in the translation database 101. And the matched translation words and their associated at least one word explanation are displayed in the sub-areas corresponding to the inquiry words. Through the above-mentioned steps, the translation area is initialized to simultaneously show several sub-areas to receive inquiry words. The inquiry words in the sub-areas are translated for displaying the corresponding translation words and at least one associated word explanation. In addition, there can be step 225 before step 230. In step 225, a cursor is used to extract several words, each of which is embedded into a sub-area as the corresponding inquiry word. This will be explained in further detail later.

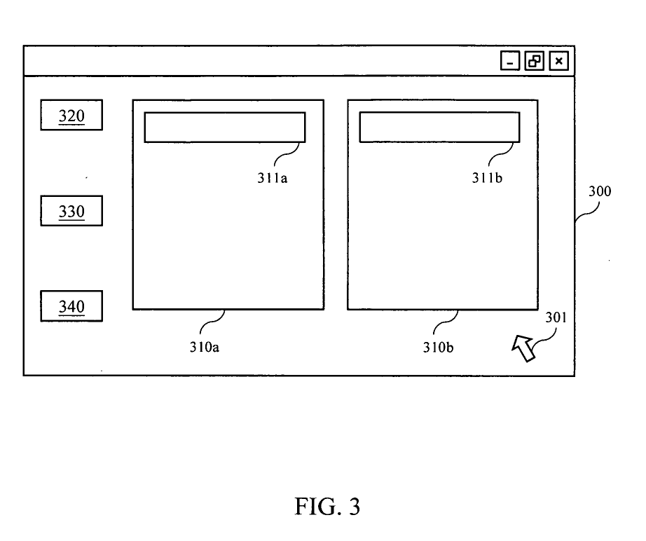

FIGS. 3 to 8 shows an embodiment of the invention. First, please refer to FIG. 3, which schematically shows the translation area of the invention. The translation area 300 includes: sub-areas 310a, 310b, input elements 311a, 311b, switch display element 320, deleting element 330, and adding element 340. In practice, the translation area 300 is a window interface operated through the cursor 301. It should be emphasized that the invention does not restrict the number and type of elements contained in the translation area 300.

When a user wants to translate several words, he can start the translation area 300. While starting the translation area 300, the initializing module 102 initializes the translation area 300. For example, it executes the function of translation inquiry view twice to produce the translation area 300 shown in FIG. 3. In this example, the translation area 300 contains two sub-areas 310a, 310b.

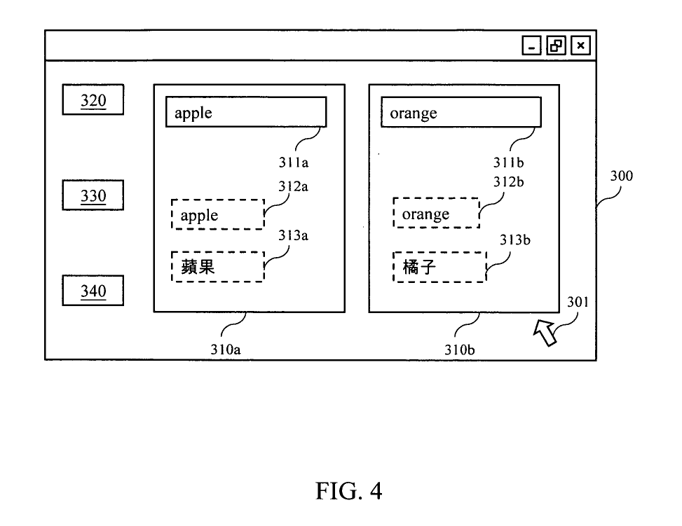

Please refer to FIG. 4, which is a schematic view of using the invention to simultaneously translate two inquiry words. As mentioned before, the user has started the translation area 300 with two sub-areas 310a, 310b. Suppose the user wants to search for the meanings of “apple” and “orange.” He enters the word “apple” in the input element 311a of the sub-area 310a and the word “orange” in the input element 311b of the sub-area 310b. In this case, the receiving module 103 receives the words entered by the user in the sub-area 310a and the sub-area 310b, respectively, as the corresponding inquiry words.

Afterwards, the translating module 104 compares the inquiry words “apple” and “orange” received by the receiving module 103 with all the translation words in the translation database 101. Suppose the translation database 101 already has the translation words “apple” and “orange.” Then the translating module 104 obtains the translation words “apple” and “orange” as the matched results after the comparison. Therefore, the translating module 104 displays the matched translation word 312a (i.e., “apple”) and its word explanation 313a (i.e., “apple (in Chinese)”) in the sub-area 310a and the matched translation word 312b (i.e., “orange”) and its word explanation 313b (i.e., “orange (in Chinese)”) in the sub-area 310b.

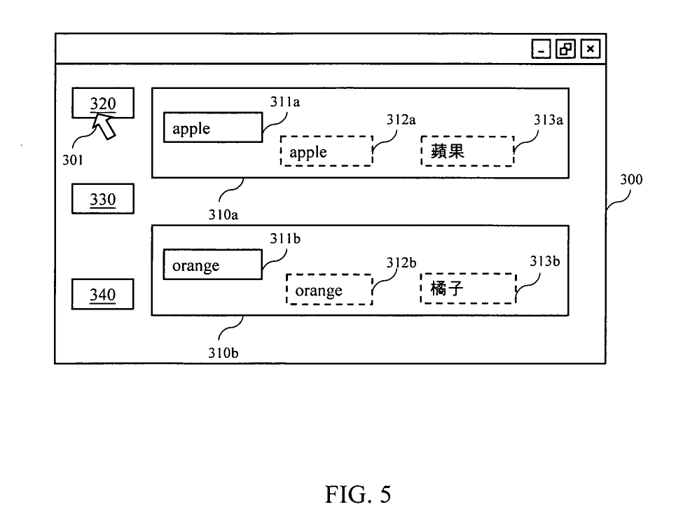

FIG. 5 is a schematic view of switching the arrangement of the sub-areas according to the invention. As mentioned before, the sub-areas 310a, 310b can have horizontal or vertical display simultaneously. In practice, the user can use the cursor 301 to click the switch display element 320. In this case, all of the sub-areas 310a, 310b are displayed horizontally, as shown in FIG. 5. The positions of the input elements 311a, 311b, the translation words 312a, 312b, and the word explanations 313a, 313b in the sub-areas 310a, 310b are simultaneously adjusted. Although this example illustrates the horizontal display mode, the invention does not restrict the display method of the sub-areas 310a, 310b. Any display method that can simultaneously show multiple sub-areas should be covered by the invention.

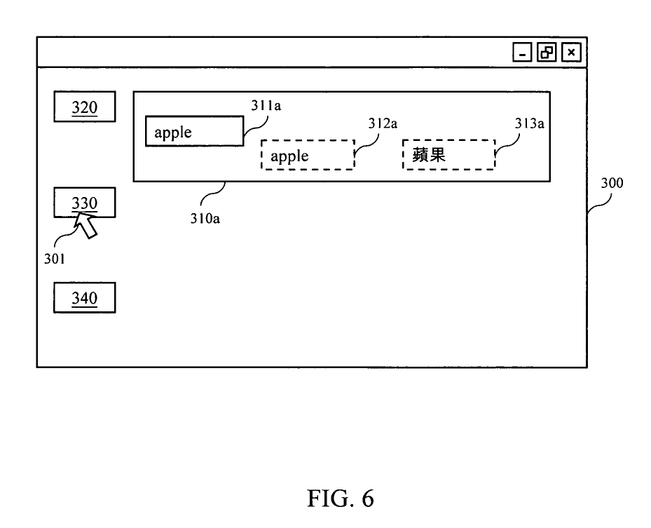

FIG. 6 is a schematic view of deleting a sub-area according to the invention. In addition to switching the arrangement of the sub-areas 310a, 310b, after selecting a sub-area 310b the user can use the cursor 301 to click the deleting element 330 in order to delete the selected sub-area 310b. The result after the deletion is shown in FIG. 6, where the translation area 300 only has a single sub-area 310a.

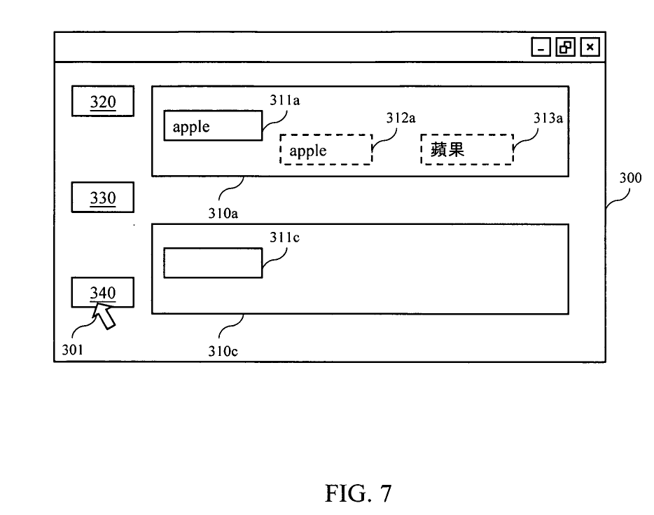

FIG. 7 is a schematic view of adding a sub-area according to the invention. As mentioned before, the user can use the cursor 301 to click the deleting element 330 in order to delete the selected sub-area 310b. In addition, the user can also use the cursor 301 to click the adding element 340 in order to add a sub-area 310c. The newly added sub-area 310c also has an input element 311c for the user to enter a word as the inquiry word and for displaying the matched translation word and its word explanations.

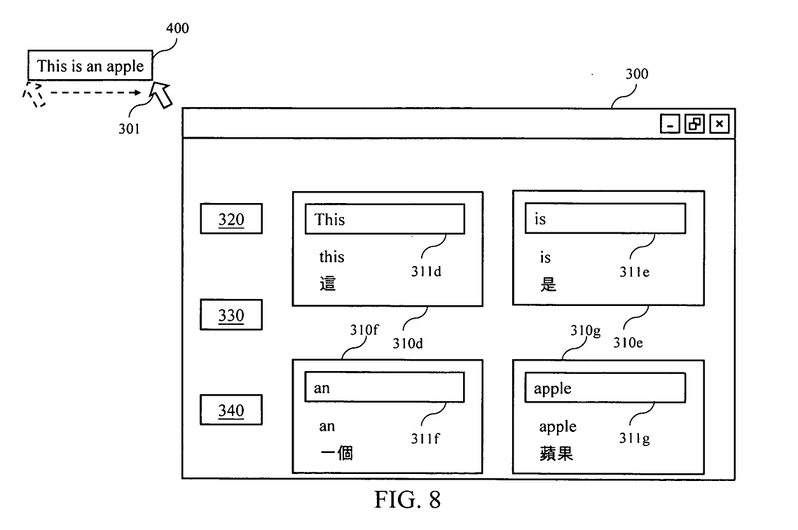

FIG. 8 is a schematic view of using the cursor to simultaneously extracting several words for translation according to the invention. As mentioned before, the user can enter words in the input elements 311a, 311b of the sub-areas 310a, 310b as the inquiry words. In practice, the user can use the cursor 301 to mark and select text 400, as shown in FIG. 8. In this case, the extracting module 110 extracts the marked text 400 as several words, such as “This,” “is,” “an,” and “apple.” The extraction method can be done by dividing the selected text 400 into individual words according to “space” and “punctuation.” Since the decomposition method belongs to the prior art, it is not further described herein.

Afterwards, the extracting module 110 embeds the words into the sub-areas 310d to 310g as the corresponding inquiry words. In practice, the extracting module 110 can generate sub-areas according to the number of words, so that each of the words can be embedded into a different sub-area as the inquiry word. In this example, the number of words is “4.” Therefore, the extracting module 110 executes the function of generating translation inquiry view four times in the translation area 300, thereby generating four sub-areas 310d to 210g of different ID's. The extracting module 110 embeds the word “This” into the input element 311d of the sub-area 310d, the word “is” into the input element 311e of the sub-area 310e, the word “an” into the input element 311f of the sub-area 310f, and the word “apple” into the input element 311g of the sub-area 310g. These words are the inquiry words of the corresponding sub-areas 310d to 310g for translation. The translation results are the displayed in the corresponding sub-areas 310d to 310g, as shown in FIG. 8. It should be mentioned that the size of the four sub-areas 310d to 310g can be computed according to the size of the translation area 300. Suppose the translation area 300 is a rectangle of “400*400” pixels. Since there are four sub-areas 310d to 310g, by dividing the translation area 300 equally into four parts one knows that each of the four sub-areas 310d to 310g is a rectangle of “200*200” pixels, as computed from “400/2=200.” Moreover, they are displayed in a 2×2 array. Even though the above example is used to illustrate how the invention decide the size and display method of the four sub-areas 310d to 310g, the invention does not impose any constraint on the arrangement. Any method of computing the size of sub-areas and arranging the sub-areas should be covered by the invention.

In summary, the invention differs from the prior art in that the invention initializes the translation area 300 so that it can simultaneously display multiple sub-areas for receiving inquiry words. The inquiry word in each of the sub-areas is translated. The matched translation word and its associated at least one word explanation are shown in the corresponding sub-area. Thus, the disclosed technique can solve the existing problem in the prior art, increasing the convenience in comparing translation words.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A displaying system of translation words, comprising:
a translation database for storing a plurality of translation words, each of which has at least one word explanation;
an initializing module for initializing a translation area that include a plurality of sub-areas;
a receiving module for receiving an inquiry word in each of the sub-areas; and
a translating module for comparing each of the inquiry words with the translation words in the translation database and displaying matched translation word and the at least one associated word explanation in the corresponding sub-area.

2. The displaying system of translation words according to claim 1, wherein the translation area allows the addition and/or deletion of a sub-area.

3. The displaying system of translation words according to claim 1, wherein the sub-areas are displayed in a horizontal or vertical array.

4. The displaying system of translation words according to claim 1, wherein each of the sub-areas is a floating window that is moved by pressing a function key or using the cursor to drag.

5. The displaying system of translation words according to claim 1 further comprising an extracting module for using the cursor to simultaneously extract a plurality of words and embedding the words into the sub-areas as the corresponding inquiry words.

6. A displaying method of translation words, comprising the steps of:
storing in a translation database a plurality of translation words, each of which has at least one word explanation;
initializing a translation area that includes a plurality of sub-areas;
receiving an inquiry word in each of the sub-areas; and
comparing each of the inquiry words with the translation words in the translation database, and displaying the matched translation word and the at least one associated word explanation in the corresponding sub-area.

7. The displaying method of translation words according to claim 6, wherein the translation area allows the addition and/or deletion of a sub-area.

8. The displaying method of translation words according to claim 6, wherein the sub-areas are displayed in a horizontal or vertical array.

9. The displaying method of translation words according to claim 6, wherein each of the sub-areas is a floating window that is moved by pressing a function key or using the cursor to drag.

10. The displaying method of translation words according to claim 6 further comprising the step of using the cursor to simultaneously extract a plurality of words and embedding the words into the sub-areas as the corresponding inquiry words.
